(19) United States
(12) Patent Application Publication
(10) Pub. No.: US 2026/0024285 A1
(43) Pub. Date: Jan. 22, 2026

(54) Spatial Data Sharing in Artificial Reality Environments

(71) Applicant: Meta Platforms Technologies, LLC, Menlo Park, CA (US)

(72) Inventors: Savitha Yalanadu SHIVAIAH, Lexington, MA (US); Jiawen ZHANG, San Mateo, CA (US); Laura ONU, Kirkland, WA (US)

(21) Appl. No.: 18/774,443

(22) Filed: Jul. 16, 2024

(51) Int. Cl. G06T 19/00; G06V 10/94; G06V 20/20

(52) U.S. Cl. CPC G06T 19/006; G06V 20/20; G06T 2219/024; G06V 10/945

(57) ABSTRACT

Aspects of the present disclosure are directed to sharing spatial data between co-located artificial reality (XR) systems. A first XR system can establish the spatial data for a real-world space, including spatial anchors and/or scene data corresponding to physical objects in the real-world space, and upload them to a remote computing system. Upon a determination of co-location of a second XR system with the first XR system (such as by comparing spatial or session identifiers), the second XR system can retrieve the spatial anchors and/or scene data for the real-world space, align itself within the real-world space, and execute an XR experience relative to the spatial anchors and/or scene data. Thus, both the first and second XR systems can render the virtual objects in consistent locations with consistent poses and orientations relative to the spatial data, without the second XR system having to rescan the space.

### TECHNICAL FIELD

The present disclosure is directed to sharing spatial data between co-located artificial reality (XR) systems in shared real-world environments.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a flow diagram illustrating a process used in some implementations of the present technology for establishing spatial data for a space in a real-world environment.

FIG. 5B is a flow diagram illustrating a process used in some implementations of the present technology for sharing spatial data, established for a space in a real-world environment, between artificial reality (XR) systems.

FIG. 6A is a conceptual diagram illustrating an example view from an artificial reality (XR) system, that generated spatial data corresponding to a space in a real-world environment, executing a multiuser XR checkers experience.

FIG. 6B is a conceptual diagram illustrating an example view from an artificial reality (XR) system, that obtained spatial data corresponding to a space in a real-world environment, executing a multiuser XR checkers experience.

FIG. 7 is a composite conceptual diagram illustrating example views of an XR environment in which two co-located XR systems share spatial data for a space in a real-world environment to execute a multiuser XR movie experience.

FIG. 8 is a conceptual diagram illustrating an example XR environment in which three co-located XR systems share spatial data for a space in a real-world environment to execute a multiuser XR architecture experience.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to sharing spatial data between co-located artificial reality (XR) systems. A first XR system can establish the spatial data for a real-world space, including spatial anchors and/or scene data corresponding to physical objects in the real-world space, and upload them to a remote computing system. Upon a determination of co-location of a second XR system with the first XR system (such as by comparing spatial or session identifiers), the second XR system can retrieve the spatial anchors and/or scene data for the real-world space, align itself within the real-world space, and execute an XR experience relative to the spatial anchors and/or scene data. Thus, both the first and second XR systems can render the virtual objects in consistent locations with consistent poses and orientations relative to the spatial data, without the second XR system having to rescan the space.

For example, a user of a second XR system can go to a friend's house to play a multiplayer XR boardgame. The friend, using a first XR system, previously scanned a living room in which they are located with the first XR system to capture spatial data, such as spatial anchors, as well as image data and location data (e.g., three-dimensional locations using a depth sensor) of physical objects within the living room. The first XR system can apply object recognition techniques to the image and location data to identify object types within the image data (e.g., walls, a coffee table, chairs, etc.), and use this information to generate scene data associated with the living room. This scene data can then be linked to the spatial anchors mapping the space and allowing for an XR system to map itself into that space, and can be stored by a remote computing system, such as a cloud computing system, in association with a unique space identifier.

Thus, when the friend launches the XR boardgame, the first XR system can display the virtual gameboard on a suitable surface, e.g., the coffee table. When the second XR system enters the living room, the second XR system can retrieve the spatial anchors for the living room using the space identifier (as obtained from the first XR system or the cloud computing system, allowing the second XR system to align its coordinate frame with coordinate frames of the first XR system), as well as the scene data from the first XR system linked to the spatial anchors. Thus, when the user launches the XR boardgame, the second XR system can display the virtual gameboard on the coffee table in the same location as it is positioned as seen by the first XR system, but from the viewpoint of the user of the second XR system. Thus, the second XR system can participate in the XR boardgame with the first XR system, without itself having to scan the friend's living room to generate all of the spatial anchors and the scene data needed for rendering.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The space sharing system described herein improves on existing XR techniques by having both users' XR systems share the same spatial data, e.g., spatial anchors and scene data, for a real-world space. Thus, each XR system (and thus, each user) would know where they are relative to each other, and relative to virtual objects rendered consistently on each XR system, without each XR system having to independently capture the spatial data. A first XR system can capture spatial anchors that specify a map of the world around that XR system. These spatial anchors can then be stored to a central system, such as a cloud computing system. When a second XR system is in the same location (or upon detection of one or more other triggers, as discussed herein), it can identify spatial anchors and also retrieve spatial anchors and other spatial data for that area from the central system. By aligning the one or more of the spatial anchors the second XR system has detected with the corresponding spatial anchors from the central system, the second XR system can identify itself within the map defined by the greater set of anchor points from the central system. Using this map, the second XR system can then track itself in the real-world space and ensure that virtual objects appear to stay at the same position and orientation within the scene (i.e., are world-locked).

In some implementations, the first XR system can further scan the area to specify object locations and types within a defined scene lexicon (e.g., desk, chair, wall, floor, ceiling, doorway, etc.). This scene identification can be performed, e.g., through a user manually (i.e., making user input to the first XR system) identifying a location with corresponding object types or with a camera to capture images of physical objects in the scene and use computer vision techniques to identify the physical objects as object types. The system can then store the object types in relation to one or more of the spatial anchors defined for that area.

The second XR system can obtain the spatial anchor and/or scene data from the central system by using a unique identifier (i.e., a space identifier) associated with the real-world space. In some implementations, the space identifier can be obtained from the first XR system, e.g., by employing local communication technology such as Bluetooth, based upon an audible announcement of the space identifier to the second user and/or second XR system, etc., such as upon detection of co-location of the first and second XR systems. In other implementations, the space identifier can be obtained from a remote computing system (e.g., platform computing system) to which the spatial data was uploaded. For example, the second XR system can gather one or more spatial anchors (or other features) of the real-world space and upload such anchors to the remote computing system. The remote computing system can match such spatial anchors to existing spatial data for the real-world space (such as uploaded by the first XR system), and provide the space identifier for the space to the second XR system (and, in some cases, the corresponding spatial data for the real-world space, either together with or separately from the space identifier). In some implementations, the remote computing system can determine the proper space identifier and/or spatial data to provide to the second XR system based on a common session identifier shared between the first and second XR systems, with the session identifier indicating that the first and second XR systems are co-located and/or that the first and second XR systems are within a same instance of a launched XR application. The second XR system can then render virtual objects with respect to the physical objects in the real-world space using the scene data (e.g., as an augmented reality (AR) or mixed reality (MR) experience), without having to rescan the scene for the physical objects itself. Thus, the implementations described herein can result in time savings, improved efficiency, and lower processing requirements for the first XR device.

Further, conventionally, users need to take manual steps in order to invite, join, and participate in a shared co-located experience. For example, in conventional systems, users have to manually communicate a specific room code to their co-located friends so they can all join the same room. Further, each user's XR system must manually scan the real-world environment in order to obtain spatial data for rendering an XR experience. There is no awareness that the users of the XR application are physically present together, or that other XR systems have already obtained spatial data for the shared space. Thus, aspects of the present disclosure provide a specific improvement in the field of multiuser (e.g., multiplayer) XR experiences by allowing users to get started in a local multiuser mode faster and with fewer steps. Users can use their XR systems to quickly discover nearby XR systems and sessions and successfully share all necessary spatial data, as noted above, so that an XR experience can be joined together in a short time. By reducing the number of steps needed to establish and join a co-located session, as well as to obtain spatial data for a shared real-world space, the user experience is improved and compute resources on the XR systems are conserved (e.g., battery power, processing power, etc.). Thus, the XR systems can commit further resources to rendering the XR experience, thereby improving processing speed and latency.

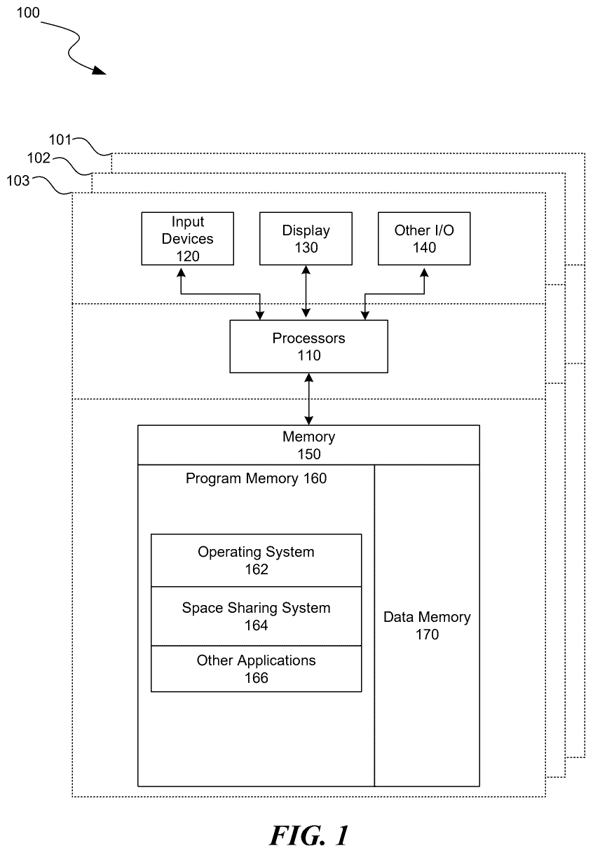

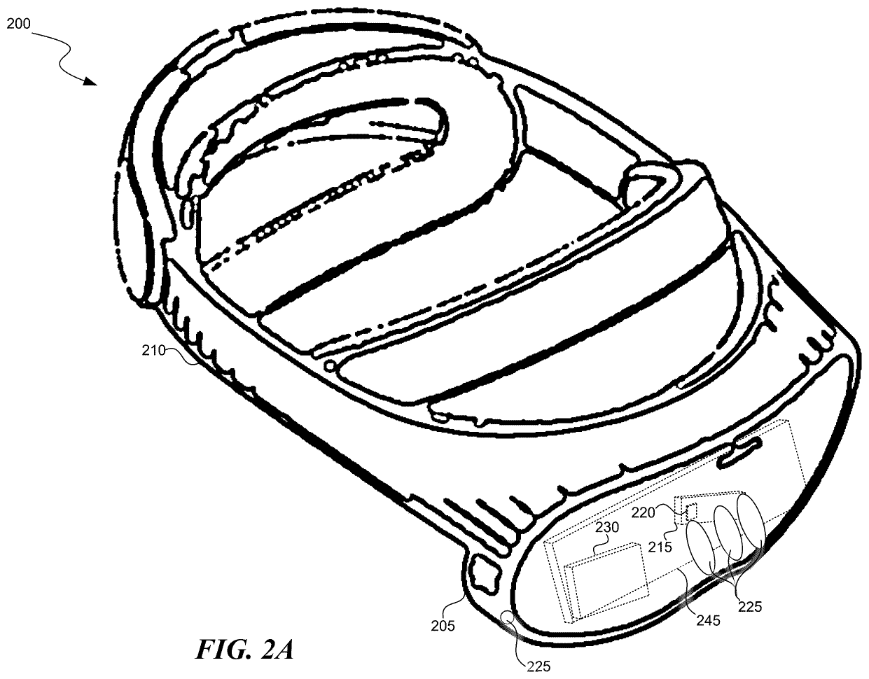

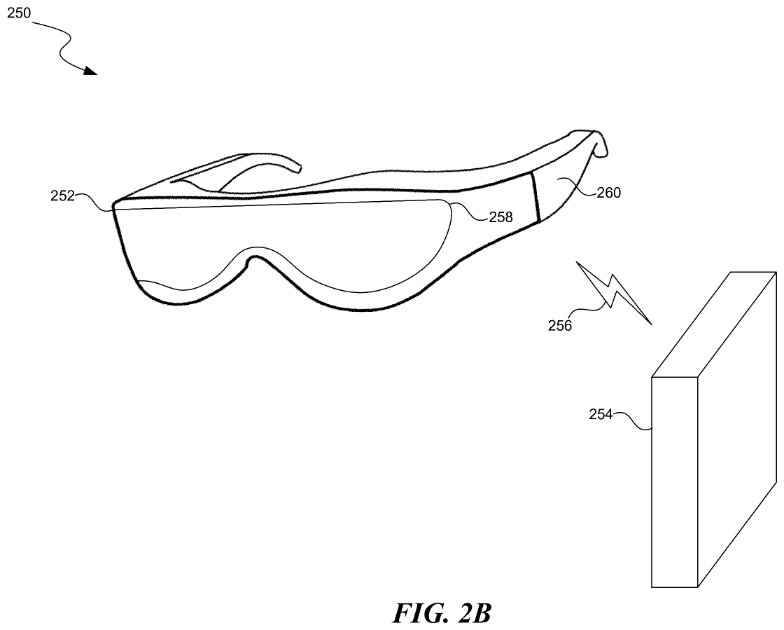

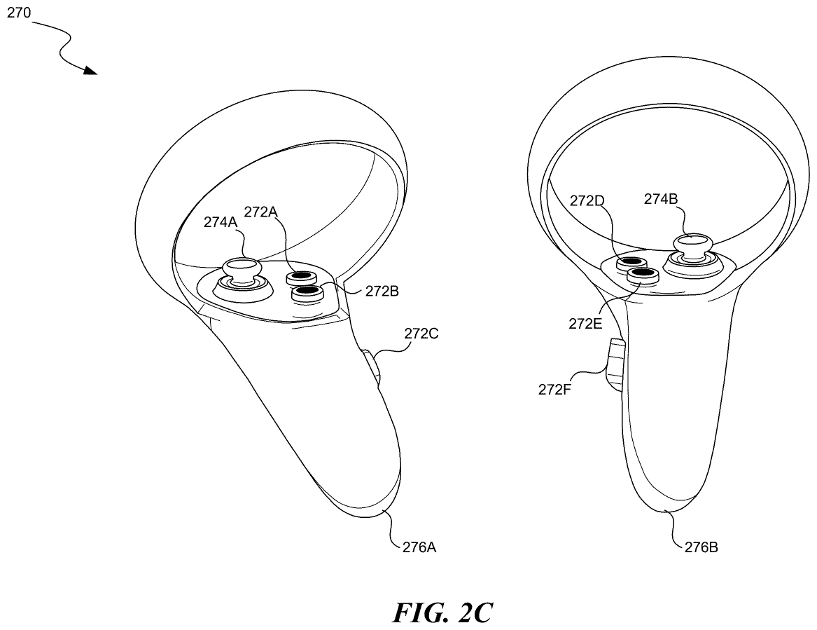

Several implementations are discussed below in more detail in reference to the figures. FIG. 1 is a block diagram illustrating an overview of devices on which some implementations of the disclosed technology can operate. The devices can comprise hardware components of a computing system 100 that can share spatial data between artificial reality (XR) systems. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, space sharing system 164, and other application programs 166. Memory 150 can also include data memory 170 that can include, e.g., identifier data, spatial data, space feature data, localization data, rendering data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHZ link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

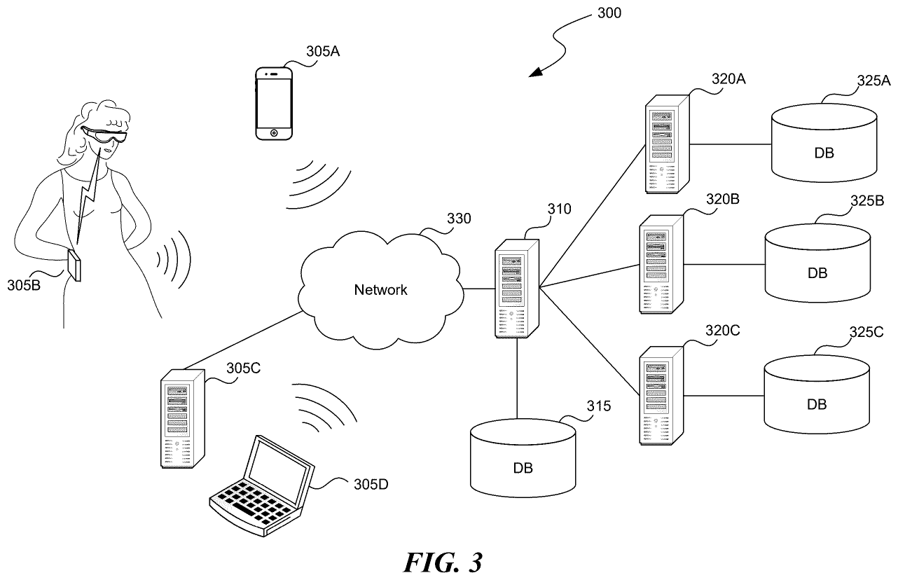

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

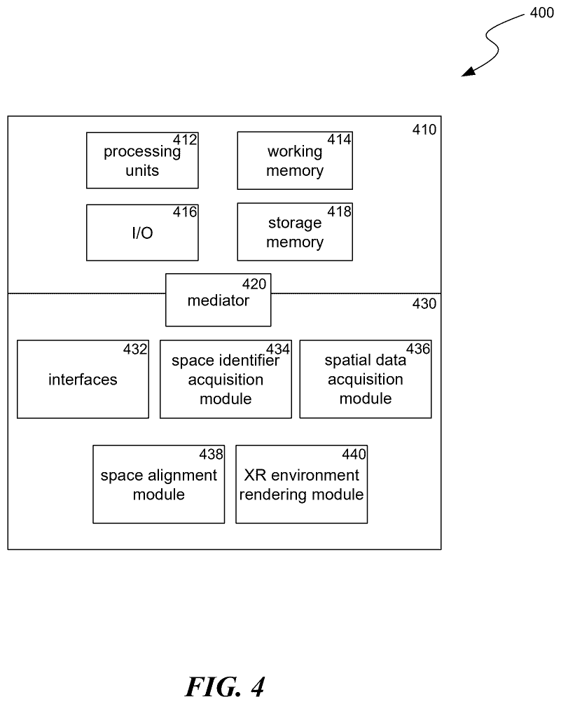

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for sharing spatial data between artificial reality (XR) systems. Specialized components 430 can include space identifier acquisition module 434, spatial data acquisition module 436, space alignment module 438, XR environment rendering module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Space identifier acquisition module 434 can obtain a space identifier for a space in a real-world environment. The space can be any indoor or outdoor area or portion of an area, such as, for example, a room, a dwelling, an open area, an office, a retail establishment, a yard, etc., in which a first XR system previously executed an XR experience. While within the space, the first XR system can gather spatial data for the space, such as spatial anchors and scene data (described further herein), and upload such data to a remote computing system for storage. Either the first XR system or the remote computing system can assign the spatial data a unique space identifier that can be used by later XR systems (e.g., “second” XR systems) accessing the space to retrieve the spatial data for that space.

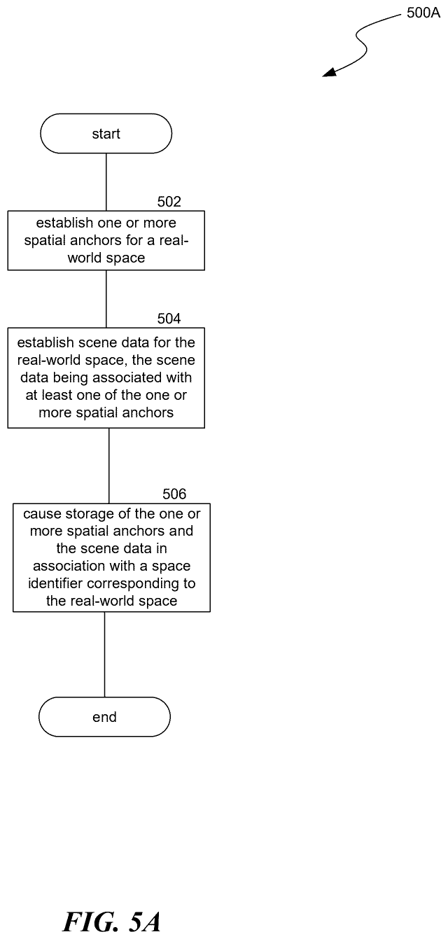

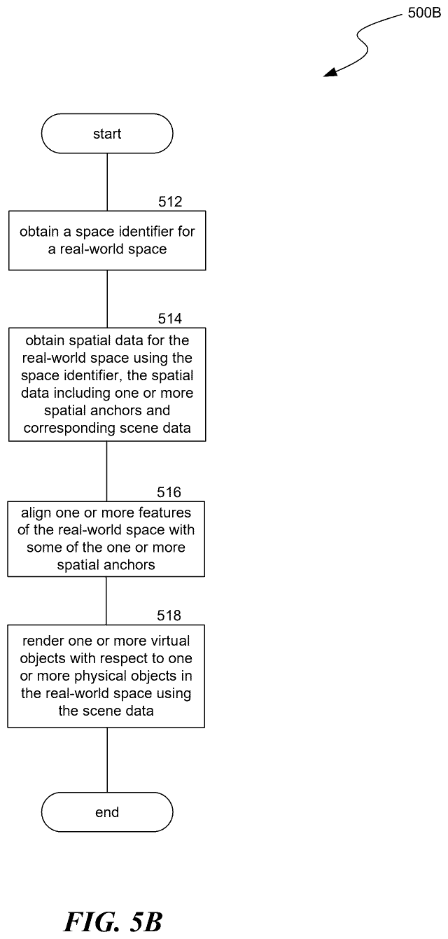

The space identifier can be in any suitable and machine-readable format, and can include, e.g., letters, numbers, symbols, graphics, etc. In some implementations, the space identifier can be descriptive, such as by including a name for the space, a name of the user of the first XR system scanning the space, a system identifier for the first XR system scanning the space, etc. For example, another (e.g., a “second XR system”), or multiple other XR systems, that are co-located with the first XR system and access the real-world space, can obtain the space identifier from, e.g., the first XR system that gathered the spatial data or the remote computing system over any suitable network (e.g., network 330 of FIG. 3). In some implementations, one or more other XR systems that are not co-located with the first XR system, but that may access the real-world space in the future, can obtain the space identifier for use when later accessing the space. The one or more other XR can be identified and/or have proper permissions or access rights based on, e.g., a social graph of the user of the first XR system relative to other XR systems (e.g., friends and family), and/or other connections between the respective users and/or XR systems (e.g., meeting a distance threshold), as described further herein. Further details regarding gathering, by an XR system, spatial data for a real-world space are described herein with respect to blocks 502-504 of FIG. 5A. Further details regarding obtaining a space identifier for a space in a real-world environment are described herein with respect to block 512 of FIG. 5B.

Spatial data acquisition module 436 can transmit a query for the spatial data for the real-world space using the space identifier, and obtain, in response to the query, the spatial data for the real-world space corresponding to the spatial identifier. Spatial data acquisition module 436 can transmit the query to, e.g., the first XR system that collected the spatial data, or a remote computing system storing the spatial data, over any suitable network (e.g., network 330 of FIG. 3). For example, when a determination of co-location is made with respect to the first XR system that collected the spatial data, spatial data acquisition module 436 can transmit the query and/or obtain the spatial data through short-range communication, such as Bluetooth, Bluetooth Low Energy (LE), near field communication, and/or the like. The first XR system and/or remote computing system can locate the spatial data by querying a database storing such data with the unique space identifier, and can transmit such spatial data back to spatial data acquisition module 436 over the same or a different network on which the request was transmitted. In some implementations, spatial data acquisition module 436 can obtain portions of the spatial data from multiple, disparate sources, such as from the first XR system (or multiple different co-located XR systems) and/or the remote computing system (or multiple different remote computing systems) using the same space identifier.

The spatial data can include one or more spatial anchors established for the space by the first XR system. Each spatial anchor can define a respective location in the space. At least one of the spatial anchors can have other corresponding spatial data, such as scene data, which, in some implementations, can also be gathered by the first XR system. However, in other implementations, at least some the scene data can be gathered by a different XR system previously accessing the space. The scene data can be generated by storing object data, associated with one or more physical objects in the real-world space. The physical objects can include fixed and/or moveable physical objects in the real-world space. The scene data can provide an identified object type from a set of object types defined as scene components in the space, with reference to the one or more locations in the space. For example, the object type can include a semantic label, such as a wall, ceiling, door, table, window, counter, etc. Further details regarding transmitting a query for spatial data for a real-world space are described herein with respect to block 514 of FIG. 5B. Further details regarding obtaining spatial data for a real-world space corresponding to a space identifier are described herein with respect to block 516 of FIG. 5B.

Space alignment module 438 can align one or more features of the space, captured by the second XR system when located within the space, with at least some of the one or more spatial anchors obtained by spatial data acquisition module 436. For example, space alignment module 438 can itself capture at least some spatial data (e.g., one or more spatial anchors) for the real-world space, then align the captured spatial anchors within the spatial data obtained by spatial data acquisition module 436, such as in a localization map. In another example, space alignment module 438 can capture visual features of the space via one or more images, and align such visual features with previously captured images of the space. By aligning the XR system within the real-world space, space alignment module 438 can ascertain its position and orientation within the real-world space. Further details regarding aligning one or more features of the real-world space with at least some spatial anchors are described herein with respect to block 516 of FIG. 5B.

XR environment rendering module 440 can render one or more virtual objects with respect to the one or more physical objects in the space using the scene data. In some implementations, because space alignment module 438 aligned the XR system within the existing spatial data for the real-world space, XR environment rendering module 440 can render the one or more virtual objects from the perspective of the second XR system, rather than the first XR system that collected the spatial data. In some implementations, both the XR system that collected the spatial data and XR environment rendering module 440 can render the one or more virtual objects in consistent locations, positions, and orientations in the real-world space. For example, if a first user of the first XR system is facing a virtual dog and points at it, the user of the second XR system would see the first user (or an avatar of the first user) facing the virtual dog and pointing at it at the same location and orientation in the real-world space. Further details regarding rendering one or more virtual objects with respect to one or more physical objects in a real-world space are described herein with respect to block 518 of FIG. 5B.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5A is a flow diagram illustrating a process 500A used in some implementations of the present technology for establishing spatial data for a space in a real-world environment. In some implementations, process 500A can be performed by an XR system, which can include one or more XR devices, such as an XR head-mounted display (e.g., XR HMD 200 of FIG. 2A and/or XR HMD 252 of FIG. 2B), one or more external processing components, one or more controllers (e.g., controllers 276A and/or 276B of FIG. 2C), etc. For purposes of FIGS. 5A and 5B, the XR system performing process 500A can be referred to as a “first XR system.”

In some implementations, process 500A can be performed upon activation or donning of the XR system by a user. In some implementations, process 500A can be performed based on a system-, application-, or user-level request to establish spatial data for a real-world space. As described and defined further herein, the spatial data can include one or more spatial anchors, scene data, mesh data, guardian data, XR space model data, etc.

In some implementations, process 500A can be performed upon detection of the XR system in a real-world space unrecognized by the XR system and/or upon failure of re-localization by the XR system in the real-world space. Process 500A can attempt to match the real-world space to a previously mapped real-world space by any suitable method. For example, process 500A can prompt the user to look around the room, thereby generating a mesh that can be compared with existing room meshes and/or an XR space model that can be compared to existing meshes and/or XR space models. In another example, process 500A can use one or more cameras to capture one or more images of the real-world space, identify visual features of the real-world space (e.g., corners, edges, physical objects, etc.), and compare those visual features to previously captured visual features of known real-world spaces. In still another example, process 500A can capture a localization map including one or more spatial anchors for the real-world space, and determine whether the localization map can be merged or matched to a preexisting localization map including one or more preexisting spatial anchors for the real-world space. However, it is contemplated that, in some implementations, process 500A need not attempt to re-localize in the space.

At block 502, process 500A can establish or obtain one or more spatial anchors for a space in a real-world environment. The one or more spatial anchors can each define a respective location automatically identified by one or more XR systems. As multiple XR systems are moved around real-world locations, they can scan those locations and define certain anchor points (e.g., at surfaces, edges, corners, doorways, etc.) These spatial anchors can define a map of the world around those XR systems. The spatial anchors can be world-locked frames of reference that can be created at particular positions and orientations to position content at consistent points in an XR experience. Spatial anchors can be persistent across different sessions of an XR experience, such that a user can stop and resume an XR experience, while still maintaining content at the same locations in the real-world environment.

At block 504, process 500A can establish other spatial data for the space, which, in some implementations, can be associated with at least one of the one or more spatial anchors. The spatial data can correspond to surfaces, walls, free space, physical objects, rooms, etc. In some implementations, the spatial data can include scene data. For example, the XR system can scan the real-world space to specify object locations and types within a defined scene lexicon (e.g., desk, chair, wall, floor, ceiling, doorway, etc.), which, in some implementations, can be stored alongside the defined scene lexicon as a sematic label. This scene identification can be performed, e.g., through a user manually identifying a location with a corresponding object type. In some implementations, process 500A can store the object types in relation to one or more spatial anchors defined for that area, and/or in relation to an XR space model or mesh, as described further herein.

In some implementations, process 500A can automatically obtain and/or label scene data by applying computer vision, object detection, object recognition, and/or machine learning techniques. The machine learning component, such as a neural network, can be trained using a variety of data, including images of known object types, past object types seen by the user or similar users, metadata associated with the user, contextual factors, and/or whether the user identified a predicted object type as correct or incorrect. Some implementations can feed input data including an image of an object, user metadata, and/or contextual factors into the trained machine learning component, and based on the output, can generate a predicted object type. Some implementations provide this predicted object type to a user via a display on an XR system. Some implementations receive feedback about the predicted object type to further enhance the trained model.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the trained model can be a neural network with multiple input nodes that receive input data including an image of an object, any user metadata, and/or any contextual factors. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,”) one or more nodes can produce a value classifying the input that, once the model is trained, can be used to predict an object type in the image. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes images of known object types, any user metadata, and/or any contextual factors as input and a desired output, such as a prediction of an object type. A current image of an object can be provided to the model. Output from the model can be compared to the desired output for that object type, and, based on the comparison, the model can be modified, such as by changing weights between nodes of the neural network or parameters of the functions used at each node in the neural network (e.g., applying a loss function). After applying each of the factors in the training data and modifying the model in this manner, the model can be trained to evaluate new input data.

Some implementations of the space sharing system described herein can include a deep learning component. A “deep learning model,” as used herein with respect to object recognition, refers to a construct trained to learn by example to perform classification directly from images. The deep learning model is trained by using a large set of labeled data and applying a neural network as described above that includes many layers. With respect to object recognition from images, the deep learning model in some implementations can be a convolutional neural network (CNN) that is used to automatically learn an object's inherent features to identify the object. For example, the deep learning model can be an R-CNN, Fast R-CNN, or Faster-RCNN. In some implementations, object recognition can be performed using other object recognition approaches, such as template matching, image segmentation and blob analysis, edge matching, divide-and-conquer search, greyscale matching, gradient matching, pose clustering, geometric hashing, scale-invariant feature transform (SIFT), histogram of oriented gradients (HOG), region-based fully convolutional network (R-FCN), single shot detector (SSD), spatial pyramid pooling (SPP-net), etc. Further details regarding generating, storing, and using scene data are described in U.S. patent application Ser. No. 18/069,029, filed Dec. 20, 2022, entitled “Shared Scene Co-Location for Artificial Reality Devices” (Attorney Docket No. 3589-0245US01), which is herein incorporated by reference in its entirety.

In some implementations, the spatial data can include boundary data. In some implementations, the boundary can be a “guardian.” As used herein, a “guardian” can be a defined XR usage space in a real-world environment. If a user, wearing an XR system, crosses the boundary when accessing an XR experience, one or more system actions or restrictions can be triggered on the XR system. For example, the XR system can display a warning message on the XR system, can activate at least partial pass-through on the XR system, can display the boundary on the XR system, can pause rendering of or updates to the XR environment, etc. In some implementations, the boundary can be manually generated by the user, such as by a user using one or more controllers (e.g., controllers 276A and/or 276B of FIG. 2C) to outline the boundaries of the real-world space (e.g. the accessible floor). In some implementations, process 500A can automatically generate the boundary, e.g., by identifying a continuous floor plane from one or more images captured by one or more cameras using computer vision techniques.

In some implementations, the spatial data can include XR space model data. An XR space model (referred to interchangeably herein as a “room box”) can indicate where the walls, floor, and ceiling exist the real-world space. In some implementations, process 500A can obtain the XR space model automatically. For example, a user of an XR system can scan the real-world space using one or more cameras and/or one or more depth sensors by moving and/or looking around the real-world space with the XR system, and automatically identify one or more flat surfaces (e.g., walls, floor ceiling) in the real-world space using such image and/or depth data. For example, process 500A can identify the flat surfaces by analyzing the image and/or depth data for large areas of the same color, of consistently increasing and/or decreasing depth relative to the XR system, and/or of particular orientations (e.g., above, below, or around the XR system), etc.

In some implementations, process 500A can capture the XR space model, at least in part, via detected positions of one or more controllers (e.g., controller 276A and/or controller 276B of FIG. 2C) and/or tracked hand or other body part positions. For example, the user of the XR system can move the controllers or body parts around the real-world space to, for example, outline the walls, ceiling, and/or floor with a ray projected from a controller. In another example, the user of the XR system can set the controller or body parts on the walls, ceiling, and/or floor to identify them based on the position of the controller or body part (e.g., as detected by one or more cameras on the XR device, as detected via one or more sensors of an IMU, etc.). In some implementations, process 500A can automatically capture the XR space model, which can then be refined (if necessary) via one or more controllers or positions of body parts, as described further herein. In some implementations, the XR space model can be stored with semantic labels identifying particular scene components (e.g., walls, floor, ceiling, etc.). Further details regarding generating and using XR space models are described in U.S. patent application Ser. No. 18/346,379, filed Jul. 3, 2023, entitled “Artificial Reality Room Capture Realignment” (Attorney Docket No. 3589-0262US01), which is herein incorporated by reference in its entirety.

In some implementations, the spatial data can include mesh data generated by scanning the real-world space. The mesh can be, for example, a three-dimensional (3D) model of the boundaries of the real-world space, including one or more walls, the ceiling, the floor, one or more physical objects, etc. In some implementations, process 500A can generate the mesh using one or more cameras, one or more depth sensors, or any combination thereof. In some implementations, however, it is contemplated that depth data need not be captured, and can instead be predicted from the one or more images, such as by a machine learning model. In some implementations, process 500A can further perform post-processing on the mesh to refine and/or simplify the mesh. Further details regarding generating and using XR space models and meshes are described in U.S. patent application Ser. No. 18/454,349, filed Aug. 23, 2023, entitled “Assisted Scene Capture for an Artificial Reality Environment” (Attorney Docket No. 3589-0286US01), which is herein incorporated by reference in its entirety.

At block 506, process 500A can cause storage of the one or more spatial anchors and/or other spatial data, such as scene data. In some implementations, process 500A can cause the one or more spatial anchors and/or other spatial data to be stored on a cloud or edge computing system via transmission of such data. In some implementations, process 500A can cause the one or more spatial anchors and/or other spatial data to be stored on a platform computing system, such as a computing system managed and/or controlled by a platform associated with the XR system and located remotely from the XR system, based on transmission of such data.

In some implementations, at least some of the other spatial data can be stored in association with at least one of the one or more spatial anchors (e.g., with spatial reference to one or more of the spatial anchors). The one or more spatial anchors and/or other spatial data can be stored in association with a space identifier corresponding to the real-world space. The space identifier can be any unique, random, and/or descriptive alphanumerical code, can include graphical and/or symbolic components identifying the real-world space, and/or can be a hash of identifying characteristics of the real-world space. In some implementations, the space identifier can be a random string of characters, such that no personal or identifying data is disclosed when the spatial data is transmitted. In some implementations, process 500A can generate the space identifier and provide it to the cloud or platform computing system, while in other implementations, the cloud or platform computing system can generate the space identifier. In some implementations, process 500A can further cause storage of the spatial data along with a session identifier set by an XR application executing on the XR system. The session identifier can identify an instance in which process 500A launched an XR application.

In some implementations, process 500A can further establish access controls for the one or more spatial anchors and/or other spatial data. In some implementations, the access controls can define permissions separately for different types of spatial data corresponding to the same or different locations. In some implementations, however, the access controls can define the same permissions across all types of spatial data available for particular locations. The access controls can define specific users, sets of users, types of users, user devices, etc. that can be allowed to obtain the spatial data, such as through usernames, hardware identifiers, Internet Protocol (IP) addresses or range of IP addresses, etc. In some implementations, the access controls can specify that users within a social graph of the user establishing the spatial data can access the spatial data, as defined further herein.

FIG. 5B is a flow diagram illustrating a process 500B used in some implementations of the present technology for sharing spatial data, established for a space in a real-world environment, between artificial reality (XR) systems. In some implementations, process 500B can be performed by an XR system, which can include one or more XR devices, such as an XR head-mounted display (e.g., XR HMD 200 of FIG. 2A and/or XR HMD 252 of FIG. 2B), one or more external processing components, one or more controllers (e.g., controllers 276A and/or 276B of FIG. 2C), etc. In some implementations, process 500B can be performed by space sharing system 164 of FIG. 1. For purposes of FIGS. 5A and 5B, the XR system performing process 500B can be referred to as a “second XR system.”

Although described relative to a single “second XR system,” it is contemplated that any number of one or more XR systems can perform process 500B, simultaneously, concurrently, or consecutively, in order to obtain spatial data, gathered by a first XR system or multiple first XR systems (e.g., via process 500A of FIG. 5A), for a real-world space. Process 500B can be performed at any point after process 500A of FIG. 5A. In some implementations, process 500B can be performed upon activation or donning of the XR system by a user. In some implementations, process 500B can be performed based on a system-, application-, or user-level request to obtain spatial data for a real-world space. In some implementations, the request can be a command to create a virtual reality (VR) experience rendering the real-world space, or being rendered in relation to the real-world space. In some implementations, process 500B can be performed upon detection of the XR system in a real-world space unrecognized by the XR system and/or upon failure of re-localization of the XR system in the real-world space. Process 500B can attempt to re-localize by any suitable method, such as any of the methods described above with respect to process 500A of FIG. 5A.

In some implementations, process 500B can be performed upon a determination of co-location with the XR system that performed process 500A of FIG. 5A (i.e., the “first XR system”). In some implementations, process 500B can detect co-location of the first and second XR systems via local detection technologies (e.g., Bluetooth, Bluetooth Low Energy (BLE), network service discovery (NSD), near field communication (NFC) detection, WiFi, ultrasound, virtual private server (VPS), etc.). In some implementations, process 500B can determine co-location based on a same session identifier shared between the first and second XR system, as described further herein.

At block 512, process 500B can obtain a space identifier for a space in a real-world environment in which the XR system can be located. In some implementations, process 500B can obtain the space identifier from a remote computing system, such as a cloud computing system, an edge computing system, and/or a platform computing system, via any suitable network (e.g., network 330 of FIG. 3). In some implementations, process 500B can obtain the space identifier from the XR system performing process 500A of FIG. 5A (i.e., the “first XR system” as described relative to FIG. 5A) via any suitable means, such as a wired or wireless network connection (e.g., network 330 of FIG. 3). In some implementations, process 500B can obtain the space identifier based on a social graph of a user of the first XR system, such as a user of the second XR system appearing on the social graph of the user of the first XR system, as described further herein. In some implementations, process 500B can obtain the space identifier based on another association between the users of the first and second XR systems, such as a friendship or other established relationship (e.g., membership in a group) on the XR platform or within an XR application, based on demographics (e.g., location of the users or XR systems), etc.

In some implementations, process 500B can obtain the space identifier based on a determination of co-location with another XR system, such as the first XR system described above with reference to FIG. 5A. Process 500B can determine co-location by detection by Bluetooth, Bluetooth LE, connection to a same WiFi network, connection to a same local area network (LAN), etc. In some implementations, upon detection of co-location with the first XR system, the first XR system and/or the second XR system can display a prompt allowing its respective user to become discoverable and/or share its device location. Similarly, when the first and second XR systems are co-located in the real-world space (i.e., within a threshold distance of each other), process 500B can obtain the space identifier via short range communication technology, such as Bluetooth, Bluetooth low Energy (LE), near-field communication (NFC), etc., or any other suitable network.

However, in some implementations, co-location between the first and second XR systems is not necessary. For example, process 500B can obtain the space identifier based on a predicted visit to the real-world space, such as based on location or other demographic factors, an association between the users of the first and second XR systems as described further herein, etc. In some implementations, process 500B can obtain the space identifier for the real-world space based on a predicted visit to the space by applying a machine learning model to data associated with or collected by the respective users and/or the first or second XR systems. In one example, the machine learning model can analyze previously accessed locations of the second XR system, along with contextual factors (e.g., user demographics, time of day, day of the week, time of year, etc.), to predict a visit of the second XR system to the real-world space. For example, if the second XR system frequently visits friends' houses (e.g., as established by a social graph, as established by a group association on the second XR system, etc.) to execute XR applications on Friday night, process 500B can proactively obtain the space identifiers (and, in some implementations, the associated spatial data as described herein) for one or more other friends' real-world spaces prior to the following Friday night. Thus, the number of steps needed to be performed by the second XR system in order to render an XR experience, once on-site at a friend's house, is decreased, leading to faster and more efficient execution of the XR application, and an improved and more seamless user experience.

In some implementations, process 500B can obtain the space identifier upon a determination that the XR system is in a “shared session” with another XR system (e.g., the first XR of process 500A), e.g., via a same session identifier used by both XR systems. In some implementations, the session identifier can identify an instance in which both XR systems launched an XR application that can at least partially control rendering on the XR systems. In some implementations, process 500B can obtain the space identifier from the XR application based on the shared session identifier. In some implementations, process 500B can obtain the space identifier upon a determination that the XR system (and/or the user of the XR system) meets any access control and/or permissions requirements established for accessing spatial data for the real-world space, as described further herein. It is contemplated that, in some implementations, process 500B can obtain the space identifier based on any one or any combination or two or more of the above-described triggers.

At block 514, process 500B can obtain spatial data for the space corresponding to the space identifier using the space identifier. As noted herein, the spatial data can include one or more spatial anchors each defining a respective location in the space, and at least one of the one or more spatial anchors can have other corresponding spatial data, such as scene data associated with one or more physical objects in the space. In some implementations, the spatial data can alternatively or additionally include mesh data, XR space model data, boundary data, etc. In some implementations, process 500B can obtain at least some of any additional spatial data based on its stored association with one or more spatial anchors (e.g., when additional spatial data is stored with reference to one or more spatial anchors).

For example, when the spatial data is stored by a remote computing system, process 500B can transmit the space identifier to the remote computing system, with the remote computing system thereafter retrieving the spatial data stored in association with the space identifier. In some implementations, the remote computing system can store spatial data captured by multiple different XR systems and/or spatial data captured at different times for the same real-world space in association with the same space identifier, such that all available (or a subset of all available) spatial data associated with a real-world space can be acquired. Further details regarding storage, retrieval, and application of remotely stored spatial anchors are described in U.S. patent application Ser. No. 18/068,918, filed Dec. 20, 2022, entitled “Cloud and Local Spatial Anchors for an Artificial Reality Device” (Attorney Docket No. 3589-0202US01), which is herein incorporated by reference in its entirety.

Although described primarily herein as obtaining spatial data from a remote computing system, it is contemplated that, in some implementations, process 500B can obtain the spatial data directly from the XR system performing process 500A of FIG. 5A (e.g., the “first XR system”), such as is described in U.S. patent application Ser. No. 18/183,083, filed Mar. 13, 2023, entitled “Shared Sessions in Artificial Reality Environments” (Attorney Docket No. 3589-0245US01), which is herein incorporated by reference in its entirety. Further, it is contemplated that, in some implementations, the remote computing system and/or the first XR system can limit retrieval of spatial data based on any access control and/or permissions specified for the XR system requesting the spatial data, as described further herein, including particular types of spatial data and/or spatial data corresponding to particular objects or features in the real-world space.

At block 516, process 500B can align one or more features of the space, captured by the XR system, with at least some of the spatial data. For example, process 500B can capture data representative of the space, such as one or more visual features, an XR space model, a mesh, one or more spatial anchors, scene data, etc. Process 500B can then align such captured data with the obtained spatial data to localize the XR system within the real-world space, such as by aligning captured spatial anchors with obtained spatial anchors, aligning visual features with obtained visual features, aligning a mesh or XR space model with an obtained mesh or XR space model, etc.

At block 518, process 500B can render one or more virtual objects with respect to the one or more physical objects in the space using the scene data associated with the at least one of the one or more spatial anchors. By aligning itself with existing spatial data at block 518, process 500B can render the one or more virtual objects from its own perspective instead of the perspective of the XR system capturing the spatial data (e.g., the “first XR system” performing process 500A of FIG. 5A). In some implementations, the second XR system (performing process 500B of FIG. 5B) can render the one or more virtual objects in the same position and orientation as the one or more virtual objects rendered on the first XR system with respect to physical objects within the scene. For example, the first XR system and the second XR system can display a virtual ping pong game on a physical countertop from their respective locations and orientations, without the second XR system having to generate spatial anchors and rescan the scene for scene data associated with physical objects within the scene. Thus, in some cases, the first XR system and the second XR system can participate in a multiplayer XR experience together with the virtual objects being rendered in the scene simultaneously by the first XR system and the second XR system. In other cases, the second XR system can render virtual objects, in relation to the scene data (e.g., on a wall, on the floor, on a countertop, etc.), not rendered by the first XR system.

In some implementations, it is contemplated that process 500B can render a VR experience relative to the obtained spatial data for the real-world space, such as a fully immersive, computer-generated experience. In one example, process 500B can render a computer-generated version of the real-world space including virtual objects corresponding to the physical objects in the real-world space. In other examples, process 500B can render other VR experiences that are not representative of the real-world space, but that use the obtained spatial data to render virtual objects (e.g., rendering boundaries for the real-world space in which the XR experience can be accessed).

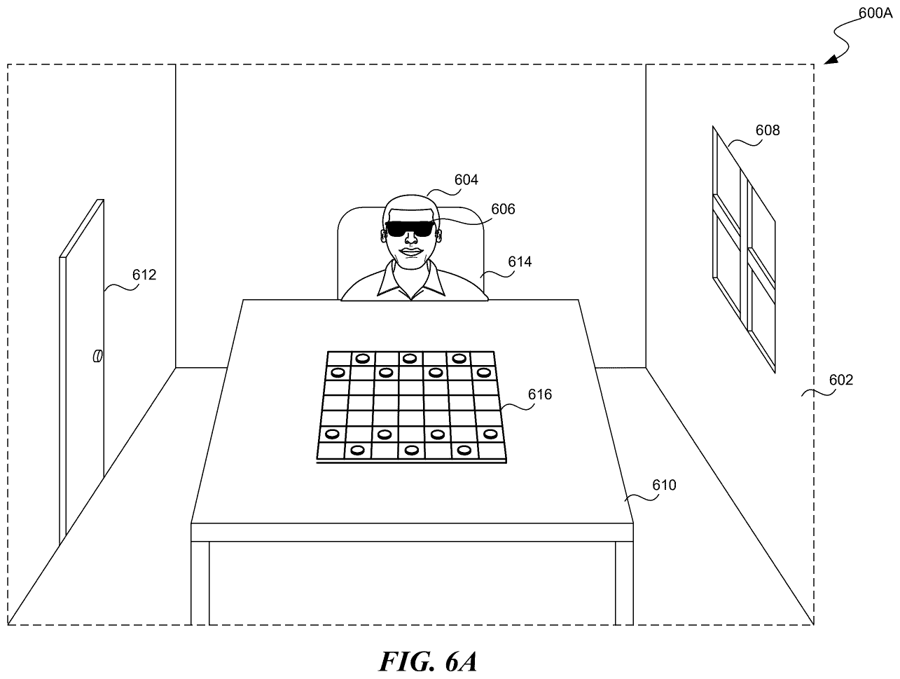

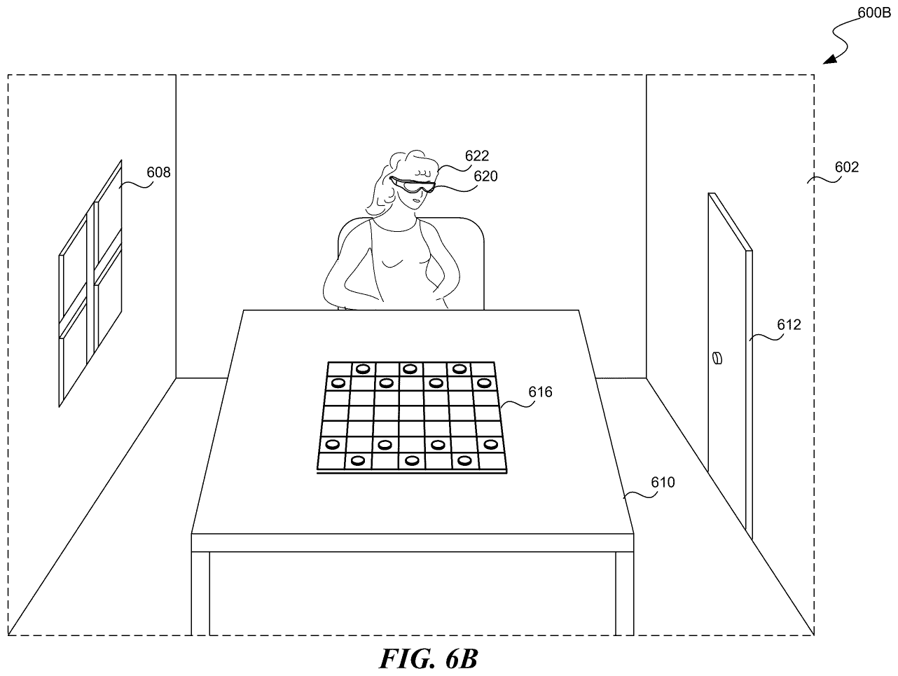

FIG. 6A is a conceptual diagram illustrating an example view 600A from an artificial reality (XR) system (e.g., first XR system 620 of FIG. 6B), that generated spatial data corresponding to a space 602 in a real-world environment, executing a multiuser XR checkers experience. First XR system 620 can capture images of space 602 by scanning space 602 with a camera integral with first XR system 620 or by identifying locations corresponding to where a user has placed a controller (e.g., controller 276A and/or controller 276B of FIG. 2C). The images can show physical objects 608-614 in space 602. In some implementations, first XR system 620 can perform object recognition on the images to identify object types associated with physical objects 608-614, e.g., window, table, door, and chair, respectively. In some implementations, user 622 of first XR system 620 can manually enter the object types associated with physical objects 608-614 on first XR system 620. First XR system 620 can generate object data associated with physical objects 608-614, and can generate scene data by storing the object data with reference to locations in space 602 (e.g., locations corresponding to spatial anchors established in space 602). First XR system 620 can then render virtual checkers game 616 in view 600A such that it appears to be placed on physical object 610 (i.e., the table).

FIG. 6B is a conceptual diagram illustrating an example view 600B from an artificial reality (XR) system (e.g., second XR system 606 associated with user 604 in FIG. 6A), that obtained spatial data corresponding to a space 602 in a real-world environment, executing a multiuser XR checkers experience. Second XR system 606 can retrieve one or more spatial anchors for space 602 in the real-world environment and align one or more features in space 602 with the obtained one or more spatial anchors, such as by aligning a captured coordinate frame with coordinate frames for first XR system 620. In some implementations, second XR system 606 can obtain scene data from first XR system 620 based on an association between one or more of the spatial anchors and the scene data (e.g., based on the locations of physical objects 608-614 with respect to the spatial anchors). Second XR system 606 can then render virtual checkers game 616 in view 600B such that it appears to be placed on physical object 610 (i.e., the table), without having to itself scan space 602 to generate the scene data. In some implementations, virtual checkers game 616 can be rendered in the same position on physical object 610 for both first XR system 620 and second XR system 606, albeit from different viewpoints respectively associated with user 622 and user 604.

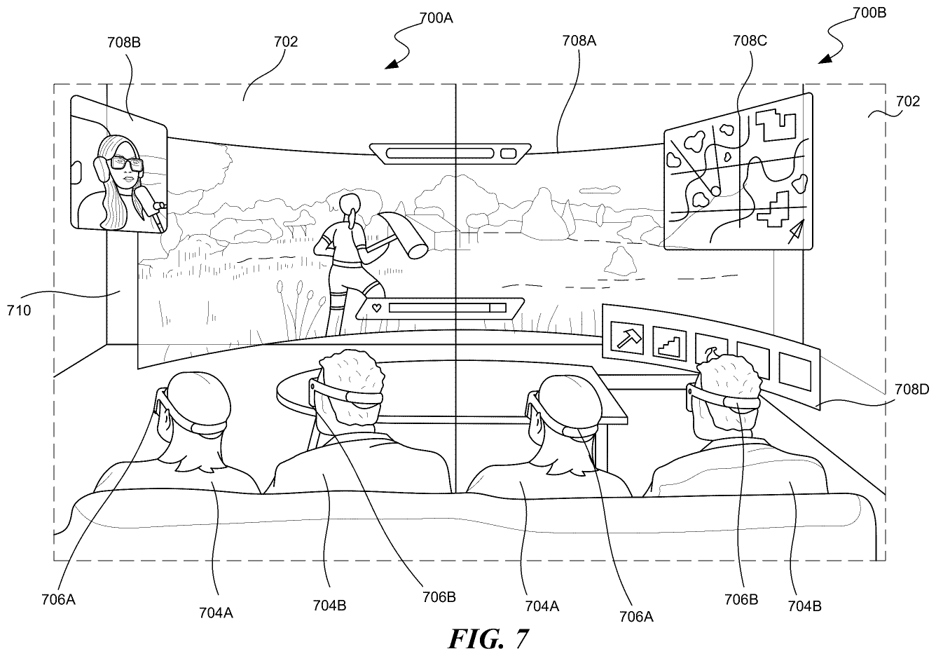

FIG. 7 is a composite conceptual diagram illustrating views 700A-700B of an example XR environment 702 in which two co-located XR systems 706A-706B share spatial data for a space in a real-world environment (e.g., a living room) to execute a multiuser XR movie experience. For example, first XR system 706A (worn by first user 704A) can gather spatial data for the real-world environment (e.g., spatial anchors, scene data, boundary data, XR space model data, mesh data, etc., as described further herein) by scanning the real-world space, manually or automatically identifying physical objects in the real-world space, etc. First XR system 706A can then upload the gathered spatial data to, e.g., a remote computing system, such as a computing system associated with a platform managing XR systems 706A-706B. In some implementations, the remote computing system can assign the spatial data a unique space identifier corresponding to the real-world space.

Second user 704B can activate or don second XR system 706B in the real-world space, enter the real-world space wearing second XR system 706B, and/or second XR system 706B can fail to re-localize in the real-world space. In some implementations, second XR system 706B can further determine co-location with first XR system 706A, such as via Bluetooth and/or other proximity detection techniques. In response to any one or combination of such triggering events, second XR system 706B can obtain a space identifier corresponding to the real-world space, such as from first XR system 706A, and/or by querying the remote computing system storing the spatial data with. The query can include, for example, one or more identifying features of the real-world space captured by second XR system 706B (e.g., one or more spatial anchors, a localization map, one or more visual features, etc.), a session identifier identifying an instance of the XR movie experience common to and launched on both first XR system 706A and second XR system 706B, a system identifier associated with first XR system 706A with which second XR system 706B is co-located, a user identifier associated with first user 704A with which second user 704B is co-located, etc. In some implementations, upon execution of the XR movie experience on second XR system 706B, the XR application can execute an application programming interface (API) to cause second XR system 706B to determine co-location of first XR system 706A and second XR system 706B, and, based on such a determination, query first XR system 706A or the remote computing system for the session identifier (or cause such a system to push the session identifier to second XR system 706B). The session identifier can then be used to query the remote computing system for the space identifier.

In some implementations, second XR system 706B can query the remote computing system for the spatial data using the space identifier. The remote computing system can store the spatial data in association with the space identifier, including one or more spatial anchors and/or other spatial data, such as scene data, boundary data, mesh data, XR space model data, etc., at least some of which can be stored in association or with reference to one or more spatial anchors. The spatial data can include data identifying, e.g., wall 710 in the real-world space (and, in some implementations, other physical features and/or objects present in the real-world space). Using one or more features of the real-world space captured by second XR system 706B (e.g., visual features, spatial anchors, scene data, mesh data, etc.), second XR system 706B can align itself within the real-world space by aligning such features with one or more spatial anchors in the obtained spatial data.

Second XR system 706B can then render virtual objects 708A-708D associated with the XR movie experience (and/or other applications or system-level functions executing on second XR system 706B) overlaid onto a view of the real-world space based on the obtained spatial data, such as is shown in view 700B. By using the same spatial data and aligning the locations, positions, and orientations of XR systems 706A-706B in a common map including such spatial data, each of users 704A-704B can see virtual objects 708A-708D rendered at the same positions and orientations in the real-world space from their respective viewpoints. In other words, because second XR system 706B aligns itself in the real-world space using the spatial data captured by first XR system 706A, second XR system 706B can view the XR movie experience from its own viewpoint and perspective, rather than that of first XR system 706A. Further, both first XR system 706A and second XR system 706B can render virtual objects 708A-708D relative to other spatial data, such as spatial data identifying wall 710.

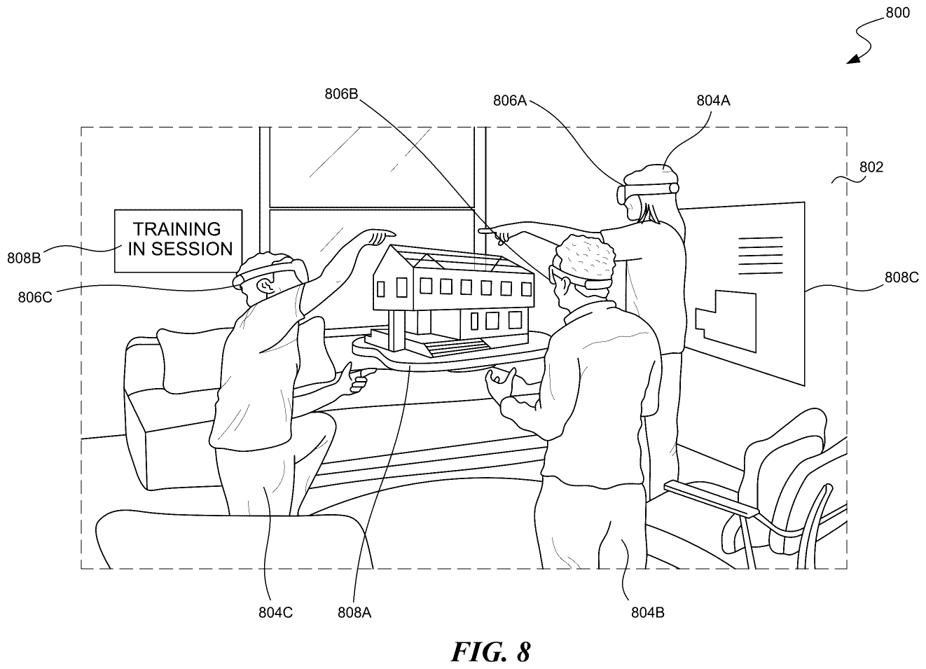

FIG. 8 is a conceptual diagram illustrating a example view 800 of an XR environment 802 in which three co-located XR systems 806A-806C share spatial data for a space in a real-world environment to execute a multiuser XR architecture experience. Any one (or multiple) of XR systems 806A-806C can capture spatial data for the real-world space hosting XR environment 802, and can upload such data to a remote computing system. The remote computing system can store such data under a common space identifier, such that other XR systems accessing the space can obtain the spatial data using the space identifier. Upon obtaining the spatial data, XR systems 806A-806C (worn by users 804A-804C, respectively) can render virtual objects 808A-808C in consistent positions and orientations in the real-world space. Thus, for example, each of users 804A-804C can see user 804C pointing at the same location on virtual object 808A, and each of users 804A-804C can see user 804A pointing at the same location on virtual object 808A. Each of users 804A-804C can similarly see consistent manipulations (e.g., movements and/or changes) made to virtual object 808A by each other from respective viewpoints.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for sharing spatial data between co-located artificial reality systems, the method comprising:
obtaining, by a second artificial reality system, a space identifier for a space in a real-world environment;
transmitting a query for the spatial data for the space using the space identifier;
obtaining, in response to the query, the spatial data for the space corresponding to the space identifier,
wherein the spatial data includes one or more spatial anchors established for the space by a first artificial reality system, the one or more spatial anchors each defining a respective location in the space, and
wherein at least one of the one or more spatial anchors has corresponding scene data associated with one or more physical objects, the scene data providing an identified object type from a set of object types defined as scene components, in the space, with reference to the one or more locations in the space;
aligning one or more features of the space, captured by the second artificial reality system, with some of the one or more spatial anchors; and
rendering one or more virtual objects with respect to the one or more physical objects in the space using the scene data associated with the at least one of the one or more spatial anchors.

2. The method of claim 1, wherein the scene data was gathered by the first artificial reality system.

3. The method of claim 2, wherein the object type is identified by performing object recognition on one or more images of the space captured by the first artificial reality system.

4. The method of claim 2, wherein the object type is identified based on input from a user of the first artificial reality system.

5. The method of claim 1, wherein, based on the aligning of the one or more features of the space, rendering the one or more virtual objects in the space is from a perspective of the second artificial reality system instead of the first artificial reality system.

6. The method of claim 1, further comprising:
obtaining the scene data based on the association between the at least one of the one or more spatial anchors and the scene data.

7. The method of claim 1, wherein the one or more virtual objects are rendered in a same position and orientation in the space by the first artificial reality system and the second artificial reality system.

8. The method of claim 1, wherein the space identifier is obtained from a common artificial reality application executing on the first artificial reality system and the second artificial reality system.

9. The method of claim 8, wherein the artificial reality application shares the space identifier with the second artificial reality system based on a same session identifier assigned to the first artificial reality system and the second artificial reality system.

10. The method of claim 1, wherein the space identifier is obtained from the first artificial reality system.

11. The method of claim 10, wherein the first artificial reality system shares the space identifier with the second artificial reality system based on a social graph associated with a user of the second artificial reality system.

12. The method of claim 1, wherein the space identifier is obtained based on one or more permissions established for the spatial data by the first artificial reality system.

13. The method of claim 1, wherein the query is transmitted to a remote computing system associated with a platform of the second artificial reality system.

14. A computer-readable storage medium storing instructions, for sharing spatial data between artificial reality systems, the instructions, when executed by a computing system, cause the computing system to:
obtaining, by an artificial reality system, a space identifier for a space in a real-world environment;
obtaining the spatial data for the space corresponding to the space identifier using the space identifier,
wherein the spatial data includes one or more spatial anchors established for the space, the one or more spatial anchors each defining a respective location in the space, and at least one of the one or more spatial anchors having corresponding scene data associated with one or more physical objects in the space;
aligning one or more features of the space, captured by the artificial reality system, with some of the one or more spatial anchors; and
rendering one or more virtual objects with respect to the one or more physical objects in the space using the scene data associated with the at least one of the one or more spatial anchors.

15. The computer-readable storage medium of claim 14,
wherein the artificial reality system is a second artificial reality system, and
wherein the one or more spatial anchors were established for the space by a first artificial reality system.

16. The computer-readable storage medium of claim 14,
wherein the artificial reality system is a second artificial reality system, and
wherein the scene data was gathered by a first artificial reality system.

17. The computer-readable storage medium of claim 14, wherein the scene data provides an identified object type from a set of object types defined as scene components, in the space, with reference to the one or more locations in the space.

18. A computing system for sharing spatial data between co-located artificial reality systems, the computing system comprising:
one or more processors; and
one or more memories storing instructions that, when executed by the one or more processors, cause the computing system to:
obtain, by an artificial reality system, a space identifier for a space in a real-world environment;
obtain the spatial data for the space corresponding to the space identifier using the space identifier,
wherein the spatial data includes one or more spatial anchors established for the space, the one or more spatial anchors each defining a respective location in the space, and at least one of the one or more spatial anchors having corresponding scene data associated with one or more physical objects in the space;
align one or more features of the space, captured by the artificial reality system, with some of the one or more spatial anchors; and
render one or more virtual objects with respect to the one or more physical objects in the space using the scene data associated with the at least one of the one or more spatial anchors.

19. The computing system of claim 18,
wherein the artificial reality system is a second artificial reality system,
wherein the space identifier is obtained from a common artificial reality application executing on a first artificial reality system and the second artificial reality system, and
wherein the artificial reality application shares the space identifier with the second artificial reality system based on a same session identifier assigned to the first artificial reality system and the second artificial reality system, and
wherein the second artificial reality system is co-located with the first artificial reality system.

20. The computing system of claim 18,
wherein the artificial reality system is a second artificial reality system, and
wherein the space identifier is obtained from a first artificial reality system.
